(19) United States
(12) Patent Application Publication
(10) Pub. No.: US 2021/0044589 A1
(43) Pub. Date: Feb. 11, 2021

(54) ACCESS CONTROL

(71) Applicant: BRITISH TELECOMMUNICATIONS PUBLIC LIMITED COMPANY, London (GB)

(72) Inventor: Jonathan ROSCOE, London (GB)

(21) Appl. No.: 15/733,655

(22) PCT Filed: Mar. 11, 2019
(86) PCT No.: PCT/EP2019/056065

§ 371 Date: Sep. 24, 2020

(30) Foreign Application Priority Data
Mar. 25, 2018 (EP) 18163825.5

(51) Int. Cl. H04L 29/06

(52) U.S. Cl. CPC H04L 63/101; H04L 63/126; H04L 63/102

(57) ABSTRACT

A computer implemented method of access control for a restricted resource includes receiving a request from an authenticated resource consumer to access the restricted resource, the request including an identifier of the consumer; accessing a set of transactions from a blockchain database based on the identifier of the consumer, each transaction corresponding to a prior security event concerning the consumer, to generate a set of prior security events; comparing the set of prior security events with an access control profile for the restricted resource; and responsive to the comparison, precluding access to the restricted resource by the consumer.

### PRIORITY CLAIM

The present application is a National Phase entry of PCT Application No. PCT/EP2019/056065, filed Mar. 11, 2019, which claims priority from European Patent Application No. 18163825.5, filed Mar. 25, 2018, each of which is hereby fully incorporated herein by reference.

### TECHNICAL FIELD

The present disclosure relates to methods of authentication access control in computer systems.

### BACKGROUND

In computer security it is common to prevent access to restricted resources by systems that are known to pose a risk by blacklisting such systems. Presence on a blacklist can arise based on, for example, historical confirmed threat associated with the system or behaviors arising in respect to the system. This approach relies on blacklists being maintained (often with the assistance of third party security software providers such as McAffee, Symantec, Spamhaus, etc.) and reliably distributed to access control components or computer systems. There are challenges generating, maintaining and distributing such blacklists. Furthermore, such blacklists provide only black or white view of a system: at a particular point in time a system is either blacklisted, or it is not, with no scope between these extremes.

### SUMMARY

Accordingly, it is desirable to provide access control that mitigates these challenges.

The present disclosure accordingly provides, in a first aspect, a computer implemented method of access control for a restricted resource comprising: receiving a request from an authenticated resource consumer to access the restricted resource, the request including an identifier of the consumer; accessing a set of transactions from a blockchain database based on the identifier of the consumer, each transaction corresponding to a prior security event concerning the consumer, to generate a set of prior security events; comparing the set of prior security events with an access control profile for the restricted resource; and responsive to the comparison, precluding access to the restricted resource by the consumer.

In some embodiments, each transaction includes an indication of a class of a corresponding security event.

In some embodiments, the class of security event for a transaction is taken from one of: an authentication failure event; an excessive access event; a data breach event; a denial of service event; and a malware event.

In some embodiments, the access control profile defines criteria in terms of classes and volumes of security events for determining whether access to the restricted resource should be precluded.

In some embodiments, each transaction in the set of transactions is committed to the blockchain database by one or more blockchain miner components, and the committing of the transaction includes verifying an authenticity of the transaction by verifying an originator of the transaction.

In some embodiments, committing of the transaction further includes verifying an authorization of the originator of the transaction to submit the transaction by the method of claim 1 in which the consumer is the originator of the transaction.

The present disclosure accordingly provides, in a second aspect, a computer system including a processor and memory storing computer program code for performing the method set out above.

The present disclosure accordingly provides, in a third aspect, a computer program element comprising computer program code to, when loaded into a computer system and executed thereon, cause the computer to perform the method set out above.

### BRIEF DESCRIPTION OF THE DRAWINGS

Embodiments of the present disclosure will now be described, by way of example only, with reference to the accompanying drawings, in which:

FIG. 1 is a block diagram a computer system suitable for the operation of embodiments of the present disclosure.

FIG. 2 is a component diagram of an arrangement for providing access control for a restricted resource in accordance with embodiments of the present disclosure.

FIG. 3 is a flowchart of a method of access control for the restricted resource of FIG. 2 in accordance with embodiments of the present disclosure.

### DETAILED DESCRIPTION OF THE DRAWINGS

Embodiments of the present disclosure employ blockchain technology to provide for sharing of system events as blockchain transactions such that a suite of such transactions serve to define a reputation for a system requesting access to a restricted resource. The transactions can further include information identifying the nature of system events providing context for a determination of reputation, and the reputation can be contextual depending on an access controller or restricted resource for which access is sought. For example, a system (identified by, e.g., a network address) having transactions recorded indicating malware propagation and port flooding events may be considered “blacklisted” by a resource checking for suitability for permitting a new network connection. In another example, a system having transactions recorded indicating multiple failed access attempts for a resource due to incorrect credentials may “blacklisted” by an access control server but may be “whitelisted” (i.e. access permitted) by a system with a web browser.

Some embodiments of the present disclosure further determine a categorization of a requesting system at a point in time by expiring or de-emphasizing event transactions exceeding a particular age.

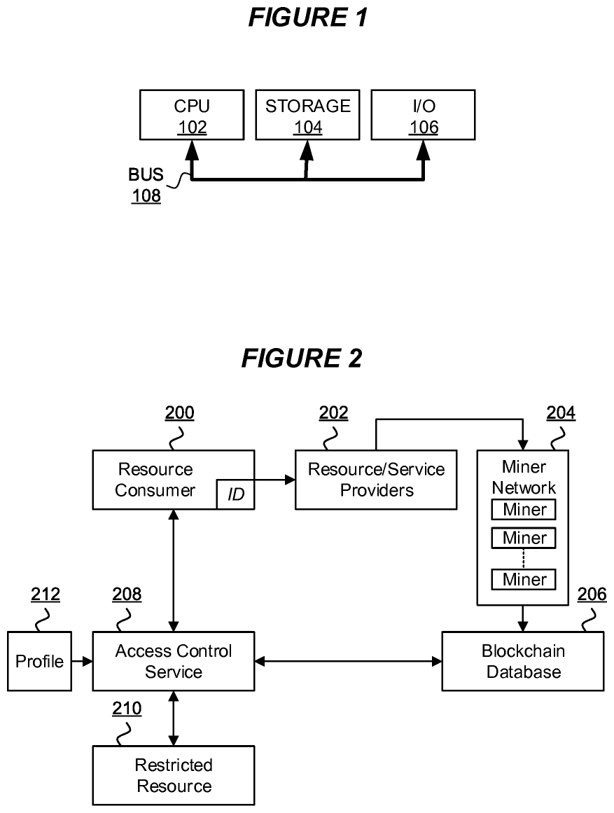

FIG. 1 is a block diagram of a computer system suitable for the operation of embodiments of the present disclosure. A central processor unit (CPU) 102 is communicatively connected to a storage 104 and an input/output (I/O) interface 106 via a data bus 108. The storage 104 can be any read/write storage device such as a random access memory (RAM) or a non-volatile storage device. An example of a non-volatile storage device includes a disk or tape storage device. The I/O interface 106 is an interface to devices for the input or output of data, or for both input and output of data. Examples of I/O devices connectable to I/O interface 106 include a keyboard, a mouse, a display (such as a monitor) and a network connection.

FIG. 2 is a component diagram of an arrangement for providing access control for a restricted resource 210 in accordance with embodiments of the present disclosure. The restricted resource 210 can be one of many types of computing resource such as, inter alia: a data storage resource such as a file repository, a database, a document store or the like; an individual file, document or item of data; a service such as a function, routine, procedure, software component, library or the like; a network such as a wired or wireless network; a peripheral device connected to a computer system; a computer system whether physical, virtualized or a combination; memory; processing resource such as one or more physical or virtual processors; interface resources such as network, peripheral, memory or other computing interfaces whether physical or virtualized; systems or services such as electronic mail, retail, financial, social media, entertainment, gaming, communication, telephony, media, media streaming, informational, infotainment or other resources; network resources such as cloud hosted software, services or systems, internet websites or the like; and other resources and types of resource as will be apparent to those skilled in the art.

Access to the restricted resource 210 is provided for resource consumers such as consumer 200 via an access control service 208 as a hardware, software, firmware or combination component. The access control service 208 undertakes a determination of whether an authenticated resource consumer 200 is permitted or precluded from accessing a requested resource such as restricted resource 210. The resource consumer 200 can be authenticated by any suitable means as are known in the art, whether by the access control service 208 or another component configured to provide authentication services. Subsequently, the access control service 208 is requested, by or on behalf of the resource consumer 200, for access to the restricted resource 210.

In undertaking its determination in respect of the access request by the consumer 200, the access control service 208 accesses a profile 212 and a blockchain database 206. In one embodiment, the profile 212 is a definition of criteria to be satisfied for the resource consumer 200 to be permitted access to the restricted resource 210. In an alternative embodiment, the profile 212 is a definition of criteria to be satisfied for the resource consumer 200 to be precluded from accessing the restricted resource 210. The profile 212 thus includes criteria defined in terms of characteristics of the resource consumer 200 that must be satisfied for the profile 212 to be considered matched. Notably, the profile 212 can be applicable to potentially multiple resource consumers and may be specific to one or more restricted resources.

The blockchain database 206 is a sequential transactional database that may be distributed and shared by multiple entities communicating via a network. Distributed sequential transactional databases are well known in the field of cryptocurrencies and are documented, for example, in “Mastering Bitcoin. Unlocking Digital Crypto-Currencies.” (Andreas M. Antonopoulos, O'Reilly Media, April 2014). For convenience, such a data structure is herein referred to as a blockchain 206 though it will be appreciated that other suitable databases, data structures or mechanisms possessing the characteristics essential for embodiments of the present disclosure could alternatively be used. Typically, a blockchain database is a distributed chain of block data structures accessed by a network of nodes, often referred to as a network of miners 204. Each block in a blockchain includes a one or more data structures, and in some exemplary blockchains a Merkle tree of hash or digest values for transactions included in a block are used to arrive at a hash value for a block which is itself combined with a hash value for a preceding block to generate a chain of blocks (i.e. a blockchain). A new block of one or more transactions is added to the blockchain 206 by such miner software, hardware, firmware or combination systems in, for example, a miner network 204. A newly added block constitutes a current state of the blockchain 206. Such miners undertake validation of substantive content of transactions (such as any criteria defined therein) and adds a block of one or more new transactions to a blockchain 206 as a new blockchain state when a challenge is satisfied as a “proof-of-work”, typically such challenge involving a combination hash or digest for a prospective new block and a preceding block in the blockchain 206 and some challenge criterion. Thus, miners in a miner network 204 may each generate prospective new blocks for addition to the blockchain 206. Where a miner satisfies or solves a challenge and validates the transactions in a prospective new block such new block is added to the blockchain 206.

In accordance with embodiments of the present disclosure, the blockchain database 206 is used for the storage of transactions corresponding to security events concerning the consumer 200 (and potentially other consumers). Such security events are occurrences arising during interoperation between the resource consumer 200 and one or more other resource/service providers 202. The resource/service providers 202 are providers of resources or services for the consumption of the resource consumer 200 such as the resources and services described hereinbefore. Where a resource/service provider 202 identifies a security event concerning the consumer 200, the provider 202 generates a new transaction for storage in the blockchain database 206. Such new transactions are received by miners in the miner network 204 and verified before being committed to the blockchain 206 as part of new committed blockchain blocks.

Verification of transactions generated by providers 202 can include any of, inter alia: verifying an originator of the transaction; verifying a signature of the provider generating the transaction; verifying an authenticity of the provider generating the transaction 202; and verifying a reputation of the provider generating the transaction 202 as will be described below.

Thus, in use, the access control service 208 is operable to retrieve a set of transactions from the blockchain database 206 for comparison with the profile 212 to determine whether access to the restricted resource 210 should be permitted or precluded. The transactions stored in the blockchain 206 thus constitute a type of reputation of the consumer generated by potentially multiple providers 202 over a period of time and reflecting security events generated in respect of actions concerning the consumer 200 over that period.

In some embodiments, security events are classified for encoding within a blockchain transaction for ease of interpretation and/or comparison by the access control service. For example, transactions can be generated by the providers 202 to reflect security events concerning the consumer 200 in categories such as, inter alia: an authentication failure event; an excessive access event; a data breach event; a denial of service event; a malware event; and other security events as will be apparent to those skilled in the art. Accordingly, in such embodiments, the profile 212 is preferably defined to include criteria in respect of such categories of security event in order that the access control service 208 can compare the blockchain transactions with the profile 212 to determine access permission. For example, the profile 212 can include criteria stipulating one or more of: a maximum number of authentication failure occurrences in a specified period of time; a maximum rate or frequency of access to resources/services; a maximum number of occurrences of data breach in respect of the consumer 200; a frequency, number or regularity of malware alerts identified in respect of the consumer; and other criteria as will be apparent to those skilled in the art. In particular, in some embodiments the profile 212 defines criteria in terms of classes (or categories) and volumes of security events, such as volumes in a defined time period or at a predetermined rate of occurrence.

Notably, security events recorded in the blockchain 206 for the consumer identify the consumer by an identifier (ID) in order that the access control service 208 can determine appropriate transactions for comparison with the profile 212. Such an identifier may derive from, originate from or be based on one or more of, inter alia: a network address of the resource consumer such as a hardware network address; a digital signature of the resource consumer; or other unique identifiers as will be apparent to those skilled in the art.

Accordingly, the transactions committed to the blockchain 206 by the miners constitute a representation of a reputation of the consumer 200 that can be checked against a profile reputation 212 before access to the restricted resource 210 is granted. Also, notably, transactions stored in the blockchain database 206 can relate to positive security occurrences such as provider 202 confirmations of authenticity, acceptable behavior, suitable security measures and the like, such that providers “vouch” for the consumer. In such embodiments the transactions in the database 206 can collectively constitute a positive reputation for the consumer 200 and the profile 212 can include criteria based on such positive indications in transactions of the blockchain 206.

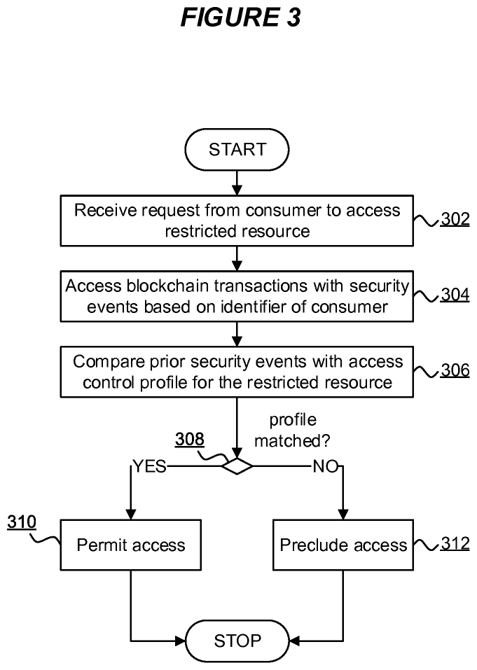

FIG. 3 is a flowchart of a method of access control for the restricted resource of FIG. 2 in accordance with embodiments of the present disclosure. Initially, at 302, the method receives a request from an authenticated resource consumer 200 for access to the restricted resource 210, the request including an identifier of the consumer 200. At 304 the method accesses a set of transactions from the blockchain database 206 based on the identifier of the consumer 200 such that each accessed transaction corresponds to a prior security event concerning the consumer 200. In this way a set of prior security events for the consumer 200 is generated. At 306 the method compares the set of prior security events with the access control profile 212, the profile being associated with the restricted resource 210. At 308 the method determines if the profile 212 is matched by the set of security events. According to the embodiment illustrated in FIG. 3, a match of the profile 212 leads to permitting the consumer to access the resource at 310 and a failure to match the profile leads to a preclusion of the consumer to access the resource at 312. Notably, in alternative embodiments a matching of the profile can lead to preclusion of access, and failure to match can lead to permitting access. Insofar as embodiments of the disclosure described are implementable, at least in part, using a software-controlled programmable processing device, such as a microprocessor, digital signal processor or other processing device, data processing apparatus or system, it will be appreciated that a computer program for configuring a programmable device, apparatus or system to implement the foregoing described methods is envisaged as an aspect of the present disclosure. The computer program may be embodied as source code or undergo compilation for implementation on a processing device, apparatus or system or may be embodied as object code, for example.

Suitably, the computer program is stored on a carrier medium in machine or device readable form, for example in solid-state memory, magnetic memory such as disk or tape, optically or magneto-optically readable memory such as compact disk or digital versatile disk etc., and the processing device utilizes the program or a part thereof to configure it for operation. The computer program may be supplied from a remote source embodied in a communications medium such as an electronic signal, radio frequency carrier wave or optical carrier wave. Such carrier media are also envisaged as aspects of the present disclosure.

It will be understood by those skilled in the art that, although the present invention has been described in relation to the above described example embodiments, the invention is not limited thereto and that there are many possible variations and modifications which fall within the scope of the invention. The scope of the present invention includes any novel features or combination of features disclosed herein. The applicant hereby gives notice that new claims may be formulated to such features or combination of features during prosecution of this application or of any such further applications derived therefrom. In particular, with reference to the appended claims, features from dependent claims may be combined with those of the independent claims and features from respective independent claims may be combined in any appropriate manner and not merely in the specific combinations enumerated in the claims.

1. A computer implemented method of access control for a restricted resource comprising:
receiving a request from an authenticated resource consumer to access the restricted resource, the request including an identifier of the consumer;
accessing a set of transactions from a blockchain database based on the identifier of the consumer, each transaction in the set of transactions corresponding to a prior security event concerning the consumer, to generate a set of prior security events;
comparing the set of prior security events with an access control profile for the restricted resource; and
responsive to the comparison, precluding access to the restricted resource by the consumer.

2. The method of claim 1, wherein each transaction in the set of transactions includes an indication of a class of a corresponding security event.

3. The method of claim 2, wherein the class of security event for a transaction is taken from one of: an authentication failure event; an excessive access event; a data breach event; a denial of service event; and a malware event.

4. The method of claim 1, wherein the access control profile defines criteria in terms of classes of security events and volumes of security events for determining whether access to the restricted resource should be precluded.

5. The method of claim 1, wherein each transaction in the set of transactions is committed to the blockchain database by one or more blockchain miner components, and the committing of the transaction includes verifying an authenticity of the transaction by verifying an originator of the transaction.

6. The method of claim 5, wherein committing of the transaction further includes verifying an authorization of the originator of the transaction to submit the transaction, wherein the consumer is the originator of the transaction.

7. A computer system comprising:
a processor and memory storing computer program code for access control for a restricted resource comprising:
receiving a request from an authenticated resource consumer to access the restricted resource, the request including an identifier of the consumer;
accessing a set of transactions from a blockchain database based on the identifier of the consumer, each transaction in the set of transactions corresponding to a prior security event concerning the consumer, to generate a set of prior security events;
comparing the set of prior security events with an access control profile for the restricted resource; and
responsive to the comparison, precluding access to the restricted resource by the consumer.

8. A non-transitory computer-readable storage medium storing a computer program element comprising computer program code to, when loaded into a computer system and executed thereon, cause the computer system to perform the method as claimed in claim 1.
